(19) United States
(12) Patent Application Publication
(10) Pub. No.: US 2015/0268809 A1
(43) Pub. Date: Sep. 24, 2015

(54) DISPLAY APPARATUS, INFORMATION PROCESSING APPARATUS, METHOD FOR CONTROLLING INFORMATION PROCESSING APPARATUS, AND COMPUTER PROGRAM

(71) Applicant: CANON KABUSHIKI KAISHA, Tokyo (JP)

(72) Inventor: Yoshiteru Horiike, Yokohama-shi (JP)

(21) Appl. No.: 14/659,306

(22) Filed: Mar. 16, 2015

(30) Foreign Application Priority Data
Mar. 18, 2014 (JP) 2014-055014
Feb. 24, 2015 (JP) 2015-033993

(51) Int. Cl. G06F 3/0485; G06F 3/0484

(52) U.S. Cl. CPC G06F 3/0485; G06F 3/04847; G06F 3/04842

(57) ABSTRACT

The present invention provides an information processing apparatus capable of preventing the occurrence of the wagon wheel effect during scrolling of displayed contents.

A CPU displays a list of a plurality of contents in a predetermined display area on the display via a display control unit. The CPU receives an operation for performing inertial scrolling on the contents displayed on the display in the display area via an input unit and a touch panel. Upon reception of an operation, the CPU performs inertial scrolling on the contents in the display area while updating the contents at predetermined time intervals, in response to the operation received at the touch panel. In this case, the CPU controls an amount of scroll movement of the contents for each of the predetermined time intervals to be equal to or less than a height of one row of the list of contents.

### BACKGROUND OF THE INVENTION

1. Field of the Invention

The present invention relates to a technique for displaying a list of data and scrolling through the list displayed (hereinafter referred to as a “list display”) on a screen.

2. Description of the Related Art

Computers having a touch panel have come into common use in recent years. When using such a computer, for example, a user displays a list of any contents on a display screen and performs a flick operation (quickly flipping the screen with the fingertip held in contact with the screen for the duration of the flick) on the list display on the screen. The user scrolls the list display on the screen in this way. Operations for scrolling the contents displayed on the display screen are not limited to a flick operation. The user can scroll the contents also by operating a scroll bar also present on the screen which moves in association with a scroll operation on the list display.

For example, assuming a list which can be scrolled with a flick operation in the vertical directions is present on an address book screen, a flick operation is intuitive and intelligible for the user to scroll the list to reach a desired row in the list. However, there is a problem that the user needs to repetitively perform a flick operation many times in comparison with a scroll bar operation.

To solve such a problem, Japanese Patent Application Laid-Open No. 2012-168890 discusses a display apparatus which increases the amount of scroll (i.e. the distance scrolled per flick) when a user repetitively performs a flick operation in the same direction.

According to the display apparatus discussed in Japanese Patent Application Laid-Open No. 2012-168890, when the user repetitively performs a flick operation in the same direction, the amount of scroll (scroll distance per flick) is increased. This enables the reduction of the number of times of flick operations performed by the user. However, when the display screen displays a list of any contents on which a flick operation in the vertical directions can be performed, for example, a phenomenon known as a “wagon wheel effect” occurs because of an optical illusion due to the increased amount of scroll. Therefore, there is a problem that the user is confused about the scrolling direction (upward or downward).

The wagon wheel effect refers to an optical illusion in which, for example, a bicycle wheel projected on a movie screen appears to be counter-rotating. A motion-picture camera generally captures 24 still images per second. For example, a bicycle wheel has 12 spokes radially connecting the wheel axis and the outer ring of the wheel. Spokes are arranged at equal circumferential distances. Assuming that the wheel rotates three times per second, when this rotation is captured by a motion-picture camera, the positional relation between spokes remains the same for each frame.

A video of the wheel captured under these conditions makes it appear as if the wheel has remained stationary because of this optical illusion. Actually, the positional relation between spokes slightly changes for each frame. However, the user cannot distinguish between one spoke and another, and therefore cannot perceive such changes. When the rotational speed of the wheel is slightly slower than 3 rotations per second, the spoke position appears to be slightly shifted in the direction opposite to the actual rotational direction for each frame. Therefore, the wheel appears to the user to be counter-rotating.

The present invention is mainly directed to providing an information processing apparatus capable of preventing the occurrence of the wagon wheel effect during scrolling of displayed contents.

### SUMMARY OF THE INVENTION

According to an aspect of the present invention, there is provided an information processing apparatus comprising display means for displaying a list of a plurality of contents in a predetermined display area; reception means for receiving an operation for performing inertial scrolling on the displayed contents in the display area; and display control means for performing inertial scrolling on the contents in the display area based on the received operation while updating the contents at predetermined time intervals, wherein the display control means is configured to control an amount of scroll movement of the contents for each of the predetermined time intervals to be equal to or less than a height of one row of the list. The aim of this is to reduce the wagon wheel effect so that a user can keep track of which way they are scrolling through their list display.

Further features of aspects of the invention are defined in claims 2 to 9.

According to a second aspect of the invention, there is provided a method for controlling the information processing apparatus as defined in claim 10.

Further features of the present invention will become apparent from the following description of exemplary embodiments with reference to the attached drawings.

### BRIEF DESCRIPTION OF THE DRAWINGS

FIG. 1 illustrates an example hardware configuration of an information processing apparatus according to a first embodiment.

FIG. 2 illustrates an example of an address selection screen displayed in a predetermined display area on a display.

FIG. 3 illustrates a scroll operation by a flick operation by a user.

FIG. 4 illustrates example scrolling methods by operations other than a flick operation.

FIGS. 5A and 5B illustrate phenomena of the wagon wheel effect.

FIG. 6 is a flowchart illustrating example processing performed by an information processing apparatus according to the first embodiment.

FIG. 7 illustrates a scroll operation by a flick operation by the user in the case of control processing illustrated in FIG. 6.

FIG. 8 is a flowchart illustrating example processing performed by an information processing apparatus according to a second embodiment.

FIG. 9 illustrates scroll operations by a flick operation by the user in the case of control processing illustrated in FIG. 8.

FIG. 10 is a flowchart illustrating example processing performed by an information processing apparatus according to a third embodiment.

FIG. 11 illustrates scroll operations by a flick operation by the user in the case of control processing illustrated in FIG. 10.

FIG. 12, comprising FIGS. 12A and 12B, illustrates a flowchart illustrating example processing performed by an information processing apparatus according to a fourth embodiment.

FIG. 13 illustrates scroll operations by a flick operation by the user in the case of control processing illustrated in FIGS. 12A and 12B.

### DESCRIPTION OF THE EMBODIMENTS

Embodiments in which the present invention is employed for an information processing apparatus will be described in detail below, by way of example only, with reference to the accompanying drawings listed above.

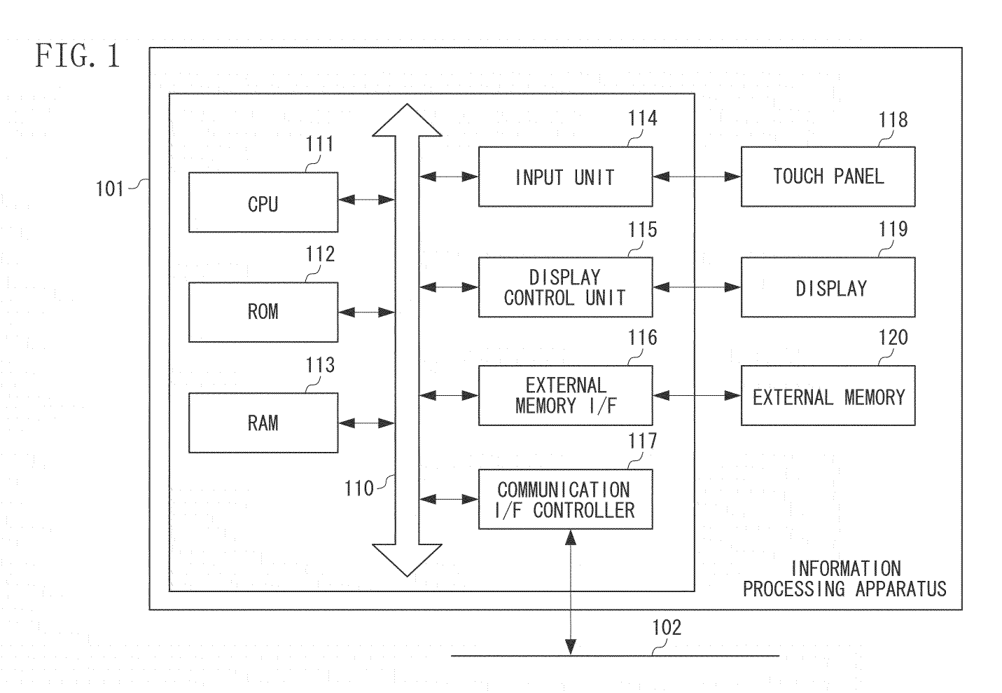

FIG. 1 illustrates an example hardware configuration of an information processing apparatus according to a first embodiment.

An information processing apparatus 101 illustrated in FIG. 1 includes a system bus 110, a central processing unit (CPU) 111, a random access memory (RAM) 112, a read only memory (ROM) 113, an input unit 114, and a display control unit 115. The information processing apparatus 101 further includes an external memory interface (I/F) 116, a communication I/F controller 117, a touch panel 118, a display 119, and an external memory 120.

These units connected to the system bus 110 are configured to exchange data with each other via the system bus 110.

For example, the CPU 111 reads programs stored in the ROM 113 into a work area of the RAM 112 and then executes these programs to control each function unit of the information processing apparatus 101. For example, the CPU 111 functions as scrolling means for controlling scroll operations (described below), and as adjustment means for adjusting the amount of movement in pixels. The ROM 113, a nonvolatile memory, stores various types of data including image data and various types of programs in respective predetermined areas. The RAM 112, a volatile memory, is used as a temporary storage area, such as a main memory for the CPU 111 and a work area. Programs required for operations of the CPU 111 are not necessarily stored in the ROM 113, and may be pre-stored in the external memory (for example, a hard disk) 120.

The input unit 114 receives an operation input from a user, generates a control signal according to the received operation content, and supplies the signal to the CPU 111. The input unit 114 functions as reception means for receiving operations, for example, via a keyboard (not illustrated), a mouse (not illustrated), and a pointing device such as the touch panel 118 (described below). The touch panel 118 is an input device which outputs coordinate information corresponding to a position, for example, on a flatly-formed input unit (such as a screen) which the user touches with their finger.

The display control unit 115 outputs a signal for displaying an image in a display screen on the display 119 serving as a display unit. For example, based on a display control signal generated by the CPU 111, the display control unit 115 functions as display means for displaying in the display screen of the display 119 a graphical user interface (GUI) screen usable for configuring the GUI.

A touch panel display integrating the touch panel 118 and the display 119 can be used. For example, the touch panel 118 is configured and disposed on the upper layer of the display screen on the display 119 such that the transmittance of light may not disturb the display on the display 119. Then, an input coordinate on the touch panel 118 and a coordinate in the display screen on the display 119 are associated with each other. Thus, a GUI can be configured in such a way that the user is able directly to operate a screen displayed on the display 119. Any one of diverse types of touch panel 118 can be used, for example, a resistance film type, a capacitance type, a surface elastic wave type, an infrared type, an electromagnetic induction type, an image recognition type, or an optical sensor type.

The external memory 120, such as a hard disk, a floppy disk, a compact disc (CD), a digital versatile disc (DVD), and a memory card, is connected to the external memory I/F 116. Under the control of the CPU 111, data is stored in and read from the external memory 120 via the external memory I/F 116.

Under the control of the CPU 111, the communication I/F controller 117 performs communication with various types of networks 102, such as a local area network (LAN), the Internet, a cable network, and a wireless network.

The CPU 111 can detect the following operation contents on the input unit of the touch panel 118 (described below) and the following states of the touch panel 118. They are, for example, a user's action to touch the touch panel 118 with the finger or a pen (hereinafter referred to as a “touch-down”), a state where the user is touching the touch panel 118 with the finger or a pen (hereinafter referred to as a “touch-on”), A user's action to move the finger or a pen held in contact with the touch panel 118 (hereinafter referred to as a “move”), a user's action to detach the finger or a pen from the touch panel 118 (hereinafter referred to as a “touch-up”), and a state where the finger or a pen is not in contact with the touch panel 118 (hereinafter referred to as a “touch-off”). Information about the above-described operation contents and position coordinate (input coordinate) on the touch panel 118 touched by the finger or a pen is transferred to the CPU 111 via the system bus 110. Based on the transferred information, the CPU 111 determines what kind of operation has been performed on the touch panel 118. For example, when the user performs a move operation, the CPU 111 can determine the moving direction of the finger or a pen moving on the touch panel 118 for each of the vertical and the horizontal components on the touch panel 118, based on changes in the position coordinates.

A user's action to quickly performing a series of actions (a touch-down, a move, and a touch-up) is referred to as a “flick.” A flick is an action to quickly flick the surface of the touch-panel 118 with the finger. When the CPU 111 detects a move at a predetermined speed or faster over a predetermined distance or further, and subsequently detects a touch-up, the CPU 111 determines that a flick has been performed. When the CPU 111 detects a move over a predetermined distance or further, and subsequently detects a touch-on, the CPU 111 determines that a “drag” has been performed.

The following describes an example case where the user uses an E-mail send function, one of data transmission functions provided by the information processing apparatus 101.

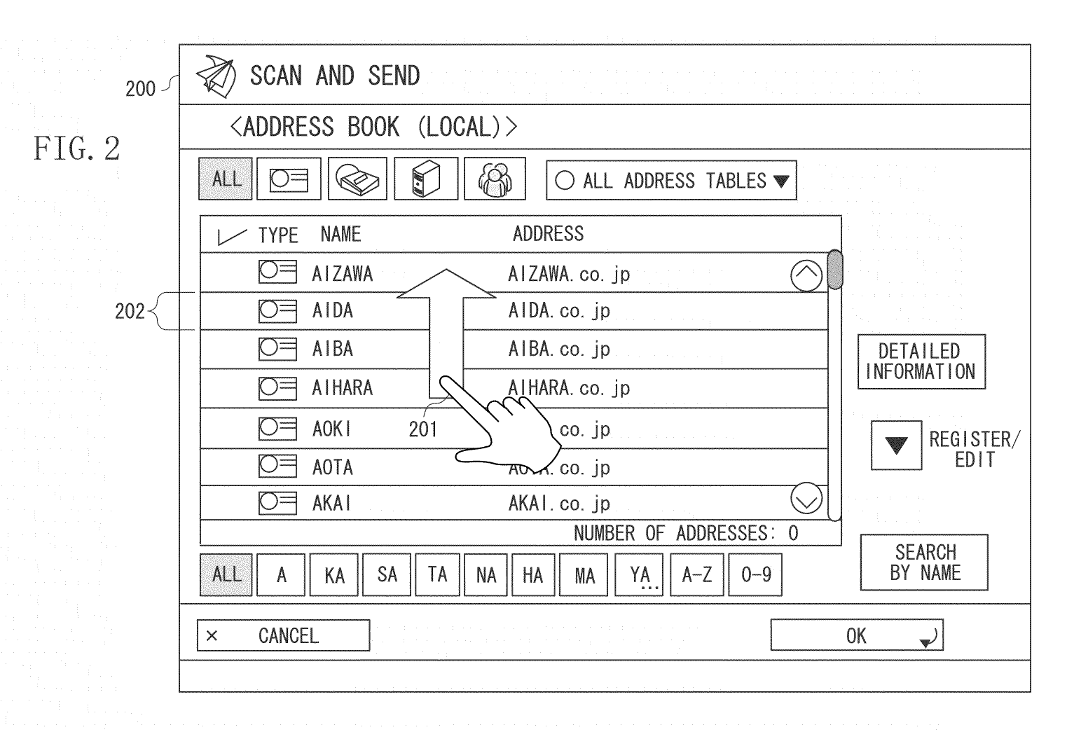

FIG. 2 illustrates an example of an address selection screen displayed in a predetermined display area on the display 119 when the user selects a destination mail address for E-mail transmission. Address book data including E-mail addresses is assumed to be pre-stored in the external memory 120 of the information processing apparatus 101.

A selection screen 200 illustrated in FIG. 2 displays address data stored in the address book. More specifically, the selection screen 200 displays address information (in the form of an address list) such as “Aizawa.co.jp” associated with names such as “Aizawa”, arranged at equal distances as a list of a plurality of addresses. As illustrated in FIG. 2, when the address book includes many address data items, the entire address list cannot be displayed in the display area on the display 119. In this case, the user needs to scroll upward or downward the address list displayed in the display area on the display 119 until a desired address appears.

For example, as illustrated in FIG. 2, the user performs a flick operation 201 in the direction of the arrow, starting from any desired position in the display area on the display 119 in which the address list is displayed. When the user performs a flick operation in the direction of the arrow, the address list displayed in the display area is scrolled upward, and an address list which has been hidden appears in the display area. The newly-presented list will be referred to as an “update” or an “updated display” hereinafter.

A list height 202 for one address indicates the height of a row in which one piece of address information is displayed. According to the present exemplary embodiment, the list height 202 is assumed to be 30 pixels. More specifically, the predetermined display area on the display 119 displays a plurality of contents at equal distances (30 pixels) as a list of a plurality of addresses.

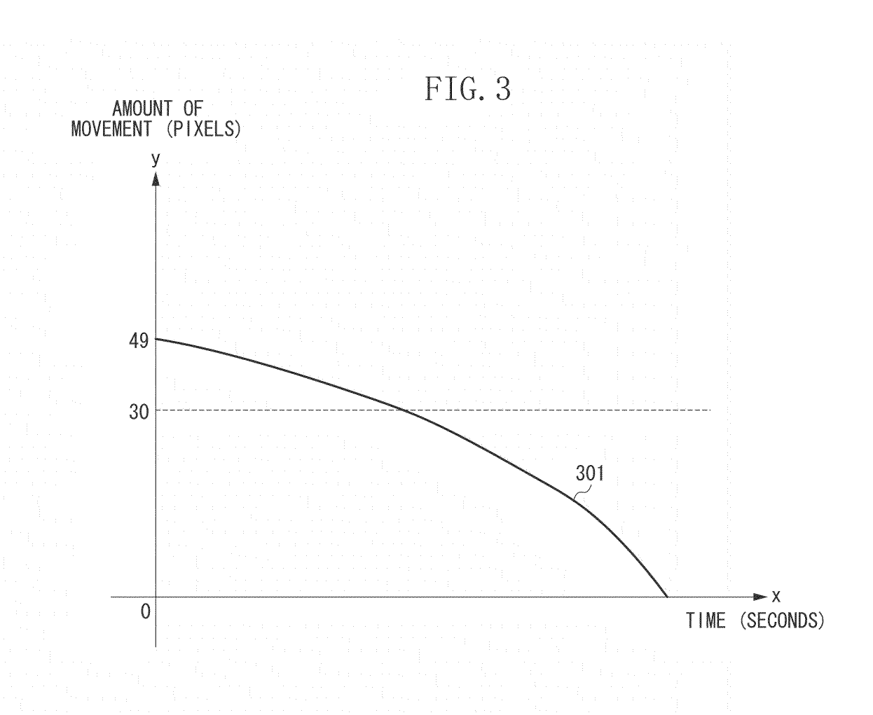

FIG. 3 illustrates a scroll operation by a flick operation by the user. When the display control unit 115 performs scrolling on the list, the list is updated (i.e. drawn or created on the screen) according to a set frame rate. For example, when the frame rate is 30 frames per second (fps), the list is updated 30 times per second. In other words, the screen is updated at intervals of about 33 milliseconds.

Referring to the graph illustrated in FIG. 3, the vertical axis (y axis) is assigned the amount of movement in pixels from the last updated display (or “update” to the next updated display (or “update”), and the horizontal axis (x axis) is assigned time (seconds). Further, a parabola 301 indicates an operation of inertial scrolling in which the amount of movement (amount of scroll) decreases with time. Inertial scrolling refers to a function in which, even after the finger is detached from the screen in a flick operation, the screen scroll operation is maintained to some extent (i.e., the screen does not suddenly stop) as if inertia were acting. The total amount of scroll from scrolling starting until it stops is determined by the strength of a flick, i.e., how strongly the user flicks the surface of the display screen.

Referring to FIG. 3, the parabola 301 indicates an example case where the amount of movement in pixels at the start of scrolling is 49 pixels. When the user performs the flick operation 201 (FIG. 2), the amount of movement in pixels at the initial display is 49 pixels. Then, each time the screen display is updated, the amount of movement in pixels gradually decreases, and eventually scrolling stops. When the amount of movement in pixels gradually decreases down to 30 pixels which equals the list height 202, the phenomenon of the wagon wheel effect is likely to occur.

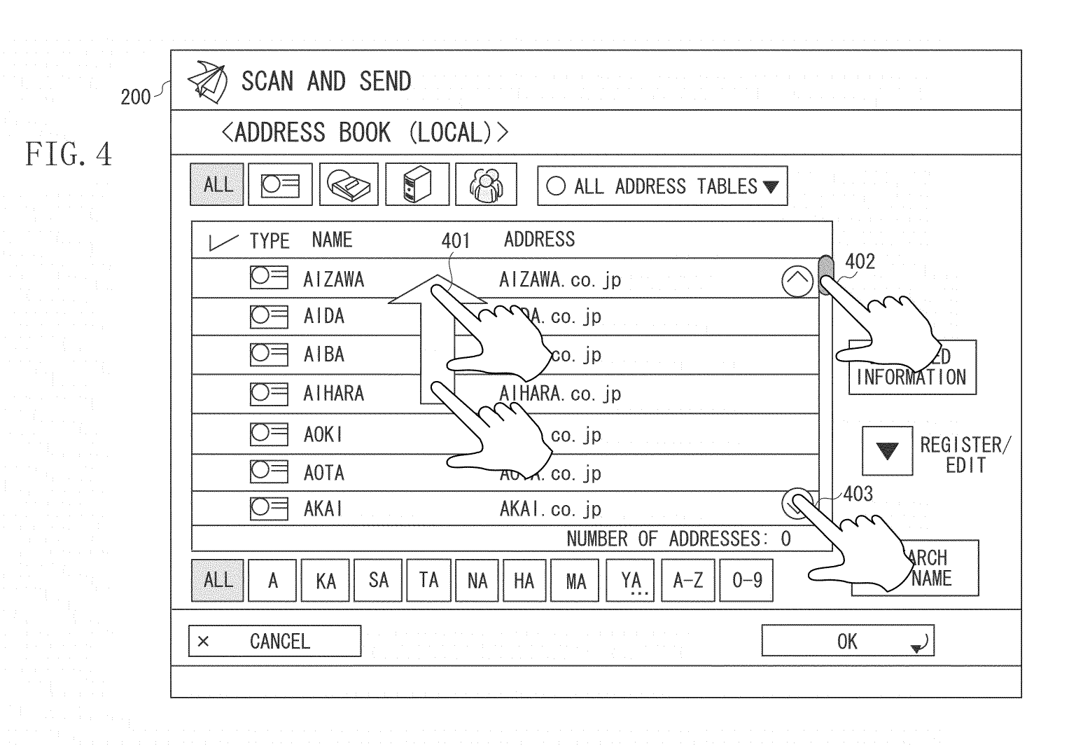

FIG. 4 illustrates example scrolling methods by operations other than a flick operation.

For example, one scrolling method is to perform a drag operation 401 in the direction of the arrow, starting from any position in the address list displayed in the selection screen 200 illustrated in FIG. 4. In this case, the screen is scrolled only by the moving distance from the position where the user performs a touch-down to the position where the user performs a touch-up.

Another scrolling method is to use a scroll bar displayed in the selection screen 200. Specifically, the user performs a touch-down on the scroll bar, and performs a drag operation 402 maintaining the touch-on state. In this case, the screen is scrolled only by the moving distance of the scroll bar.

Still another scrolling method is to press one of scroll buttons displayed in the selection screen 200. Specifically, the user performs a touch-down on one of scroll buttons (up or down arrow key), and performs an operation 403 for maintaining the touch-on state. In this case, the screen is scrolled upward or downward according to the time period during which a touch-on is maintained on the relevant scroll button.

Scrolling methods are not limited to the above-described four operations including a flick operation.

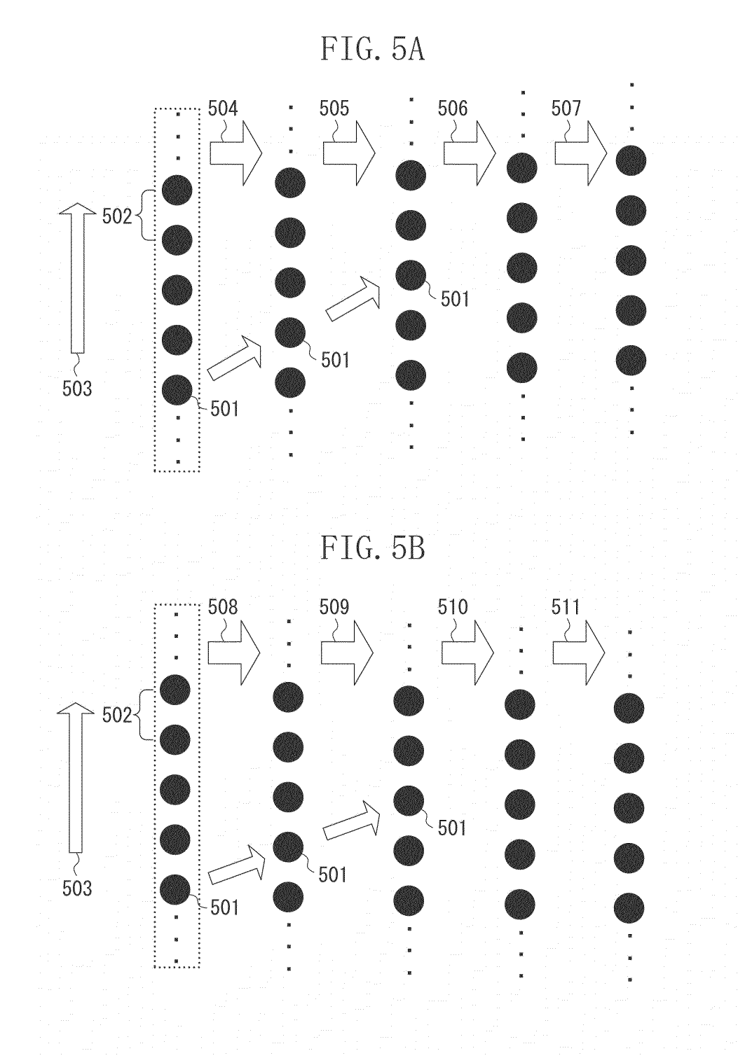

FIGS. 5A and 5B illustrate the phenomenon of the wagon wheel effect.

For example, the amount of movement in pixels at the start of scrolling by a flick operation is assumed to be set to 50 pixels. In the inertial scrolling, the amount of movement in pixels from the last update to the next update is gradually decreased at a fixed rate, for example, pixels, 49 pixels, 48 pixels, 47 pixels, and so on. Then, control is performed to stop the movement of the list, i.e., the screen scroll operation when the amount of movement in pixels from the last update to the next update becomes equal to or less than a predetermined value (for example, equal to or less than a preset scroll end value). The phenomenon of the wagon wheel effect occurs in the process of gradually decreasing the amount of movement in pixels during the inertial scrolling. Specifically, this phenomenon occurs when the amount of movement in pixels from the last update to the next update becomes around 30 pixels, which equals the list height 202. The phenomenon of the wagon wheel effect will be described in detail below with reference to FIGS. 5A and 5B.

FIG. 5A illustrates the phenomenon of the wagon wheel effect during scrolling when the amount of movement in pixels from the last update to the next update is 31 pixels. FIG. 5B illustrates the phenomenon of the wagon wheel effect during scrolling when the amount of movement in pixels is 29 pixels.

Referring to FIG. 5A, a group of black dots is surrounded by dotted lines, and a plurality of the groups continuously exists in the vertical direction when the first list display is viewed. A distance 502 between any two black dots is assumed to be 30 pixels. The group of black dots is assumed to move in the direction of an arrow 503 (from the bottom upward when the list display is viewed) in units of 31 pixels while maintaining the distance 502. Each of arrows 504, 505, 506, and 507 indicates that the screen has been updated.

When the screen is scrolled in this way, a black dot 501 moves by 31 pixels each time an update of the list display is made. However, the user cannot distinguish between the black dot 501 and others among continuous black dots. Accordingly, the user visually recognizes this movement as if the black dot 501 moved upward only by 1 pixel.

Referring to FIG. 5B, a group of black dots is surrounded by dotted lines, and a plurality of the groups continuously exists in the vertical direction when the list display is viewed. The distance 502 between any two black dots is assumed to be 30 pixels. The group of black dots is assumed to move in the direction of the arrow 503 (from the bottom upward when the update is directly viewed) in units of 29 pixels while maintaining the distance 502. Each of arrows 508, 509, 510, and 511 indicates that the screen has been updated.

When the screen is scrolled in this way, the black dot 501 moves by 29 pixels each time an update is made, for example, before and after the arrow 508. However, the user cannot distinguish between the black dot 501 and others among continuous black dots. Accordingly, the user visually recognizes this movement as if the black dot 501 moved downward only by 1 pixel. As a result, the user recognises this movement as if the screen were scrolling downward.

For example, if one black dot is recognised as one line, an optical illusion occurs when the amount of movement in pixels from the last update to the next update becomes around 30 pixels which equals the distance 502. The following describes processing performed by the information processing apparatus 101 to prevent the phenomenon of the wagon wheel effect from occurring.

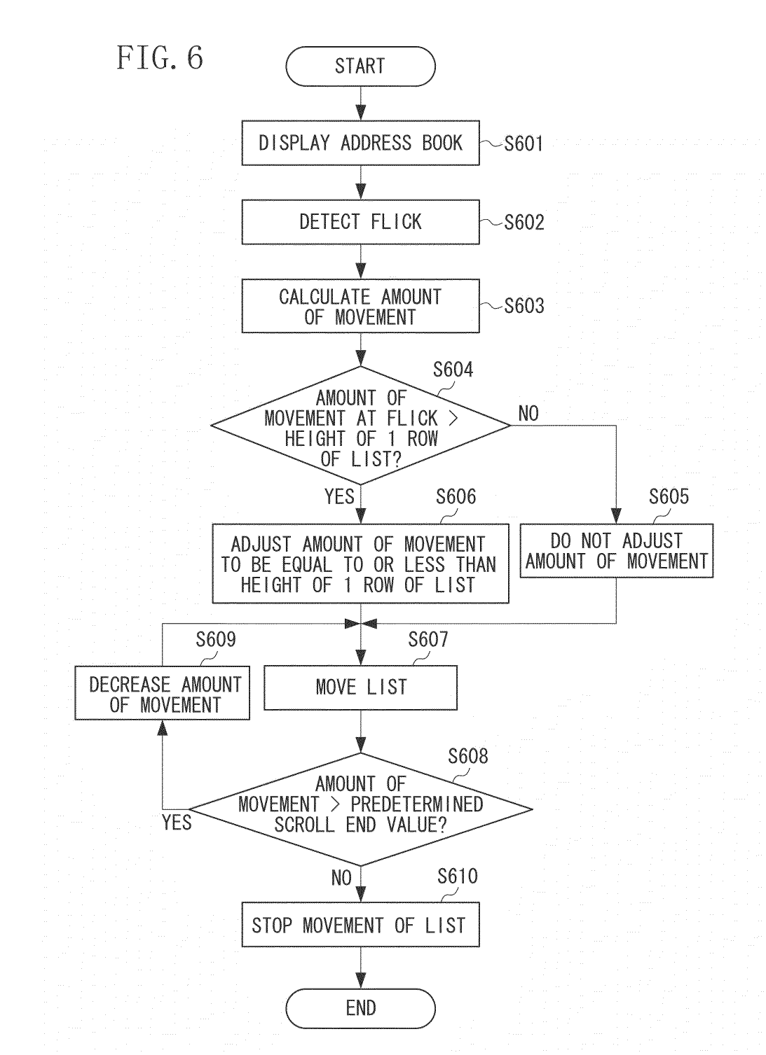

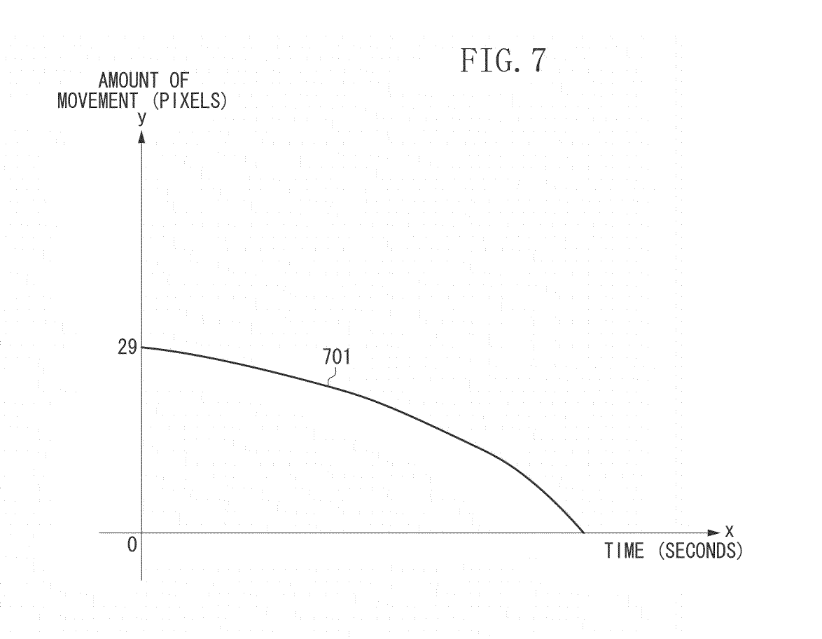

FIG. 6 is a flowchart illustrating example processing performed by the information processing apparatus 101.

Specifically, the following describes example processing performed when the user uses the E-mail send function, one of data transmission functions provided by the information processing apparatus 101, i.e., an example case of selecting an E-mail address as described above with reference to in FIG. 2. Processing in FIG. 6 is implemented when the CPU 111 reads programs stored in the ROM 113 or the external memory 120 and then executes these programs.

In step S601, the CPU 111 displays an address selection screen on the display 119 via the display control unit 115. In step S602, the CPU 111 detects a flick operation by the user.

In step S603, upon detection of the flick operation, the CPU 111 calculates the amount of movement in pixels at the start of scrolling, based on the strength of the relevant flick. For example, this description will be made on the premise that the calculated amount of movement in pixels is 50 pixels.

In step S604, the CPU 111 determines whether the calculated amount of movement in pixels per display update is larger than the list height 202 (the height of one row illustrated in FIG. 2). When the amount of movement in pixels is equal to or less than the list height 202 which is the distance between contents (NO in step S604), then in step S605, the CPU 111 does not adjust the amount of movement in pixels. When the CPU 111 does not adjust the amount of movement in pixels, the CPU 111 moves (scrolls) the address list maintaining the amount of movement in pixels calculated by the processing in step S603. On the other hand, when the amount of movement in pixels is larger than the list height 202 (YES in step S604), the processing proceeds to step S606.

In step S606, the CPU 111 adjusts the amount of movement in pixels to be equal to or less than the list height 202 which is the distance between contents. As described above, since the list height 202 is 30 pixels, the amount of movement in pixels becomes, for example, 29 pixels after adjustment. The amount of movement in pixels may be, for example, 30 pixels, 28 pixels, or 27 pixels after adjustment.

In step S607, the CPU 111 moves (scrolls) the address list while updating the screen according to the amount of movement in pixels. In step S608, the CPU 111 determines whether the amount of movement in pixels exceeds a predetermined value (the scroll end value). When the amount of movement in pixels exceeds the scroll end value (YES in step S608), then in step S609, the CPU 111 decreases the amount of movement in pixels according to the speed reduction rate of the inertial scrolling. Then, the processing proceeds to step S607. On the other hand, when the amount of movement in pixels is equal to or less than the predetermined value (the scroll end value) (NO in step S608), then in step S610, the CPU 111 stops moving the address list. The scroll end value is assumed to be set to, for example, 0 pixels as the predetermined value. The scroll end value may be 1 pixel, 2 pixels, or 3 pixels. In this way, a series of processes is completed.

FIG. 7 illustrates a scroll operation by a flick operation by the user in the case of the control processing illustrated in FIG. 6.

Referring to the graph illustrated in FIG. 7, the vertical axis (y axis) is assigned the amount of movement in pixels from the last update to the next update, and the horizontal axis (x-axis) is assigned time (seconds). Further, a parabola 701 indicates an operation of the inertial scrolling in which the amount of movement (amount of scroll) decreases with time.

Referring to the parabola 701, it can be seen that the amount of movement in pixels is adjusted to 29 pixels by the processing in step S606 since the amount of movement in pixels is calculated to be 50 pixels by the processing in step S603 illustrated in FIG. 6. More specifically, the amount of movement in pixels at the time of screen update is controlled to be equal to or less than the list height 202.

In the information processing apparatus 101 according to the present exemplary embodiment, the amount of movement in pixels from the last update to the next update in the inertial scrolling is adjusted to be equal to or less than the list height 202. For example, if the time interval of between updates determined by the frame rate is x seconds, the amount of scroll movement at intervals of x seconds is controlled to be equal to or less than the list height 202. This enables the prevention of occurrence of an optical illusion at pixel boundaries described above with reference to FIGS. 5A and 5B.

More specifically, the occurrence of the phenomenon of the wagon wheel effect can be suppressed, thus preventing the user from being confused about the scrolling direction (upward or downward).

In the above-described example according to the present exemplary embodiment, a scroll operation is performed on the address selection screen. The present invention is not limited thereto. It is natural that the present invention is also applicable to scroll operations for various contents displayed in the display screen on the display 119.

In the above-described example case according to the first exemplary embodiment, the amount of movement in pixels from the last update to the next update is adjusted to be equal to or less than the list height 202. An information processing apparatus according to a second embodiment will be described below. The information processing apparatus according to the present embodiment calculates the amount of movement in pixels and adjusts the speed reduction rate of the inertial scrolling in which the amount of movement in pixels is gradually decreased. In the present embodiment, configurations and function units identical to those in the first embodiment are assigned the same reference numerals, and redundant descriptions thereof will be omitted. The following descriptions will be made centring on differences from the information processing apparatus 101 according to the first embodiment.

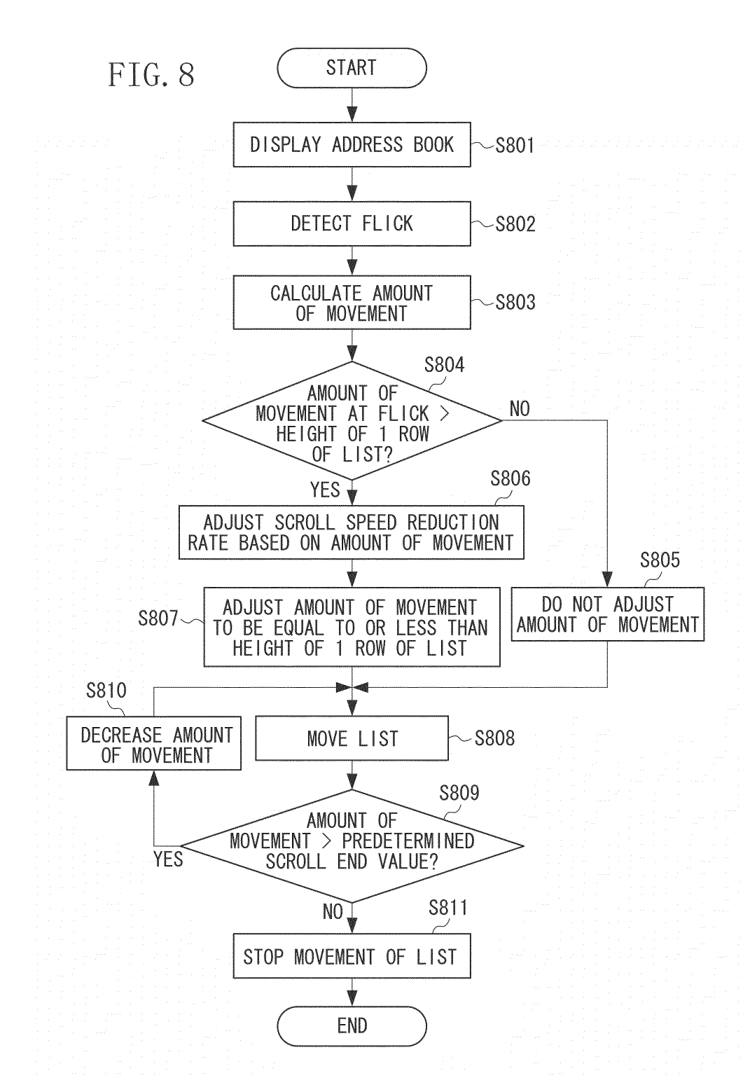

FIG. 8 is a flowchart illustrating example processing performed by the information processing apparatus according to the present embodiment.

Specifically, the following describes example processing performed when the user uses the E-mail send function, one of data transmission functions provided by the information processing apparatus 101, i.e., an example case of selecting an E-mail address as described above with reference to FIG. 2. Processing in FIG. 8 is implemented when the CPU 111 reads programs stored in the ROM 113 or the external memory 120 and then executes these programs.

Processing in steps S801 to S805 and processing in steps S807 to S811 illustrated in FIG. 8 are equivalent to the processing in step S601 to S605 and the processing in step S606 to S610 illustrated in FIG. 6, respectively. Therefore, descriptions of the relevant processing will be omitted, and descriptions will be made centring on processing in step S806 illustrated in FIG. 8.

When the amount of movement in pixels from the last update to the next update exceeds the list height 202 which is the distance between contents (YES in step S804), then in step S806, the CPU 111 adjusts the speed reduction rate of the inertial scrolling based on the amount of movement in pixels calculated in step S803. The adjustment of the speed reduction rate will be specifically described below.

In the inertial scrolling, the total amount of scroll since scrolling starts until it stops is determined by the strength of a flick. More specifically, the amount of movement in pixels is calculated according to the strength of the flick. Therefore, the speed reduction rate in the inertial scrolling differs between a case where the amount of movement in pixels is calculated to be 50 pixels and a case where it is calculated to be 70 pixels, for example, according to the strength of the flick.

In the processing in step S806, the CPU 111 adjusts the speed reduction rate of the inertial scrolling to a value according to the strength of a flick performed by the user. For example, it is assumed that the amount of movement in pixels is calculated to be 70 pixels by the processing in step S803. In this case, the CPU 111 adjusts the speed reduction rate to be lower than the value in a case where the amount of movement in pixels is calculated to be 50 pixels by the processing in step S603 illustrated in FIG. 8.

The speed reduction rate may be adjusted using the list height 202 as a reference, or adjusted in steps of a fixed value, for example, in steps of 10 pixels.

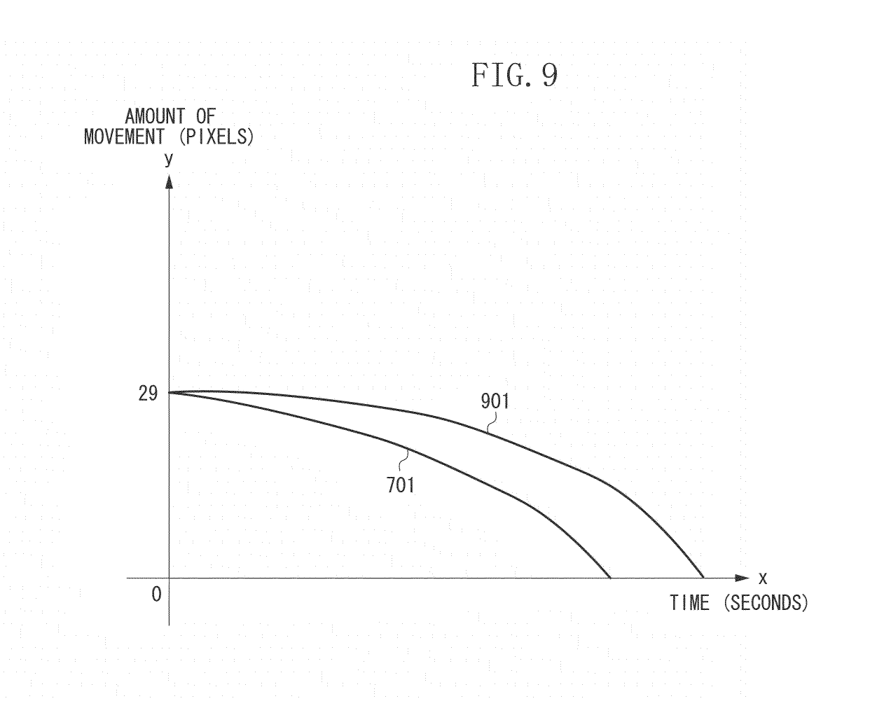

FIG. 9 illustrates screen scroll operations by a flick operation by the user in the case of the control processing illustrated in FIG. 8.

Referring to the graph illustrated in FIG. 9 the vertical axis (y axis) is assigned the amount of movement in pixels from the last update to the next update, and the horizontal axis (x axis) is assigned time (seconds). Further, parabolas 701 and 901 indicate operations of the inertial scrolling in which the amount of movement (amount of scroll) decreases with time. The parabola 701 is identical to that described above with reference to FIG. 7.

Referring to the parabolas 701 and 901, it can be seen that the amount of movement in pixels is adjusted to 29 pixels. The curve drawn by the parabola 701 indicates the speed reduction rate according to the amount of movement in pixels calculated by the processing in step S603 illustrated in FIG. 6, i.e., 50 pixels. The curve drawn by the parabola 901 indicates the speed reduction rate according to the amount of movement in pixels calculated by the processing in step S803 illustrated in FIG. 8, i.e., 70 pixels. More specifically, with the parabola 901, the speed reduction rate is adjusted according to the strength of a flick. Although the amount of movement in pixels at the start of scrolling is 29 pixels for both the parabolas 701 and 901, the parabola 901 draws a gentler curve than the parabola 701.

The information processing apparatus according to the present exemplary embodiment adjusts the speed reduction rate of the inertial scrolling according to the strength of a flick performed by the user. Thereby, when the user performs a stronger flick, the speed reduction rate of the inertial scrolling is adjusted to a smaller value. Therefore, even with the same amount of movement in pixels at the start of scrolling, the total amount of scroll can be changed according to the strength of a flick performed by the user.

This prevents the occurrence of an optical illusion at pixel boundaries, and also allows the user to easily adjust the amount of movement in screen scrolling according the strength of a flick.

In the above-described example case according to the first exemplary embodiment, the amount of movement in pixels from the last update to the next update is adjusted to be equal to or less than the list height 202. An information processing apparatus according to a third embodiment will be described below. When the amount of movement in pixels exceeds the list height 202, the information processing apparatus according to the present embodiment gradually decreases the amount of movement in pixels from the height of n rows of the list down to the height of n−1 rows of the list. In the present embodiment, configurations and function units identical to those in the first embodiment are assigned the same reference numerals, and redundant descriptions thereof will be omitted. The following descriptions will be made centring on differences from the information processing apparatus 101 according to the first embodiment.

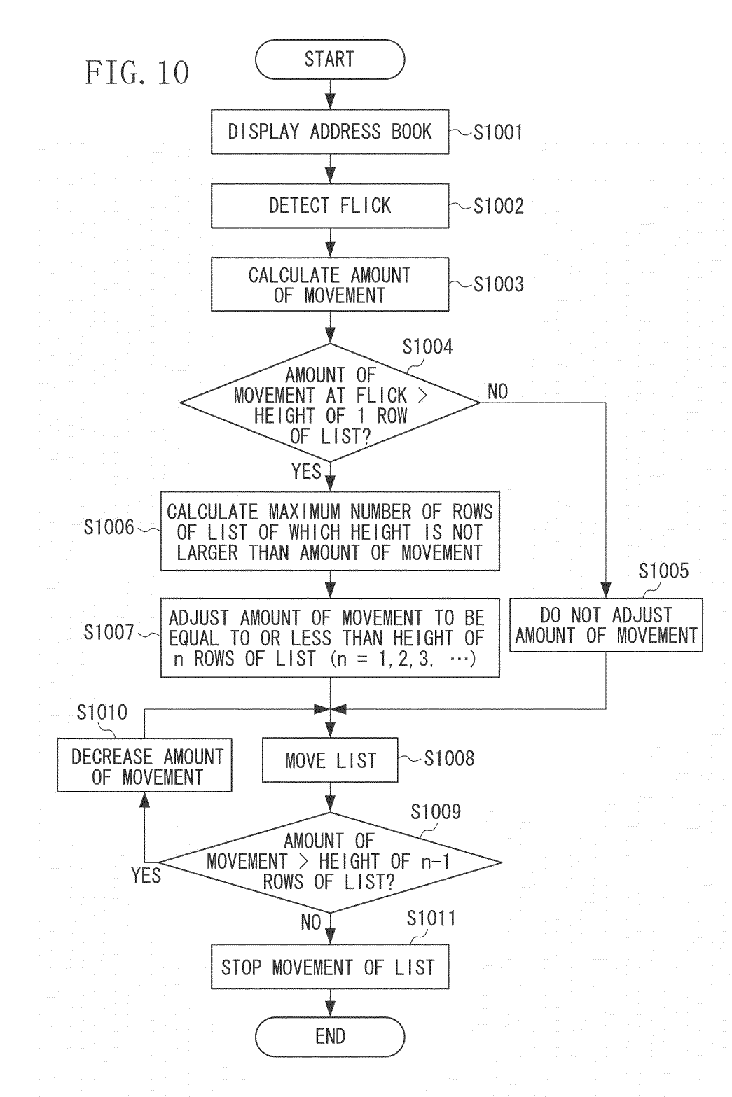

FIG. 10 is a flowchart illustrating example processing performed by the information processing apparatus according to the present embodiment.

Specifically, the following describes example processing performed when the user uses the E-mail send function, one of data transmission functions provided by the information processing apparatus 101, i.e., an example case of selecting an E-mail address as described above with reference to FIG. 2. Processing in FIG. 10 is implemented when the CPU 111 reads programs stored in the ROM 113 or the external memory 120 and then executes these programs.

Processing in steps S1001 to S1005 and processing in steps S1008, S1010, and S1011 illustrated in FIG. 10 are equivalent to the processing in steps S601 to S605 and the processing in steps S607, S609, and S610 illustrated in FIG. 6, respectively. Therefore, descriptions of the relevant processing will be omitted, and descriptions will be made centring on processing in steps S1006, 1007, and 1009 illustrated in FIG. 10.

When the amount of movement in pixels from the last update to the next update exceeds the list height 202 which is the distance between contents (YES in step S1004), then in step S1006, the CPU 111 calculates the maximum number of rows of the list of which the height is not larger than the amount of movement in pixels calculated in step S1003. As an example of calculating the relevant maximum number of rows of the list, it is assumed that the amount of movement in pixels is calculated to be 80 pixels by the processing of step S1003, and that the list height 202 is 30 pixels. In this case, since the amount of movement in pixels, 80 pixels, is twice as large as the list height 202 plus 20 pixels, the amount of movement in pixels is calculated to be equal to or larger than the height of 2 rows of the list. In other words, since dividing 80 pixels by 30 pixels gives an integral quotient of 2, it is determined that the calculated amount of movement in pixels is equal to or larger than the height of 2 rows of the list.

In step S1007, the CPU 111 adjusts the amount of movement in pixels to be equal to or less than the height of n rows of the list. Specifically, since the integral quotient calculated by the processing in step S1006 is 2, n equals 2. The CPU 111 adjusts the amount of movement in pixels to be equal to or less than a value of the product of the integral quotient (n=2) and the distance between contents (30 pixels). As a result, the amount of movement in pixels is adjusted, for example, to 59 pixels. The amount of movement in pixels may be, for example, 60 pixels, 58 pixels, or 57 pixels after adjustment.

In step S1009, the CPU 111 determines whether the amount of movement in pixels exceeds the height of n−1 rows of the list. When the amount of movement in pixels becomes equal to or less than a value of the product of the integral quotient (n=2) minus 1 and the distance between contents (30 pixels) (NO in step S1009), then in step S1011, the CPU 111 stops the movement (scroll operation) of the address list.

On the other hand, when the amount of movement in pixels exceeds the height of n−1 rows of the list, i.e., 30 pixels (YES in step S1009), then in step S1010, the CPU 111 decreases the amount of movement in pixels according to the speed reduction rate of the inertial scrolling. Then, the processing proceeds to step S1008.

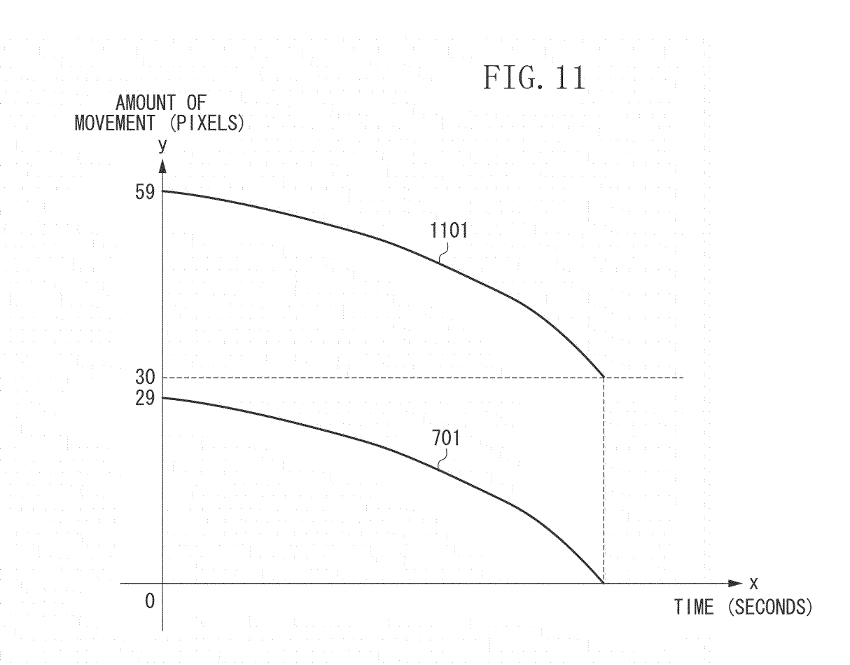

FIG. 11 illustrates screen scroll operations by a flick operation by the user in the case of the control processing illustrated in FIG. 10.

Referring to the graph illustrated in FIG. 11, the vertical axis (y axis) is assigned the amount of movement in pixels from the last update to the next update, and the horizontal axis (x axis) is assigned time (seconds). Further, parabolas 701 and 1101 illustrate operations of the inertial scrolling in which the amount of movement (amount of scroll) decreases with time. The parabola 701 is identical to that described above with reference to FIG. 7.

Referring to the parabola 1101, it can be seen that the amount of movement in pixels is adjusted to 59 pixels by the processing in step S1007 since the amount of movement in pixels is calculated to be 80 pixels by the processing in step S1003 illustrated in FIG. 10.

It can be further seen that the amount of movement in pixels is gradually decreased from 59 pixels at the start of scrolling and then scrolling is stopped when the amount of movement in pixels becomes 30 pixels which equals the height of n−1 rows of the list. More specifically, control is performed to stop scrolling when the amount of movement in pixels becomes 30 pixels which equals the height of n−1 rows of the list.

In the information processing apparatus according to the present embodiment, the amount of movement in pixels from the last update to the next update in the inertial scrolling is adjusted to be equal to or less than the height of n rows of the list. Therefore, the amount of movement in pixels at the start of scrolling can be changed according to the strength of a flick performed by the user while preventing the occurrence of an optical illusion.

This prevents the occurrence of an optical illusion at pixel boundaries, and also allows the user to easily adjust the amount of movement in screen scrolling according the strength of a flick.

In the above-described examples according to the third embodiment, when the amount of movement in pixels from the last update to the next update exceeds the list height 202, the information processing apparatus gradually decreases the amount of movement in pixels from the height of n rows of the list down to the height of n−1 rows of the list. An information processing apparatus according to a fourth embodiment will be described below. When the amount of movement in pixels from the last update to the next update exceeds the list height 202, the information processing apparatus according to the present embodiment gradually decreases the amount of movement in pixels from the height of n rows of the list down to a value of the sum of the height of n−1 rows of the list and a predetermined threshold value. In the present embodiment, configurations and function units identical to those in the first exemplary embodiment are assigned the same reference numerals, and redundant descriptions thereof will be omitted. The following descriptions will be made centring on differences from the information processing apparatus 101 according to the third embodiment.

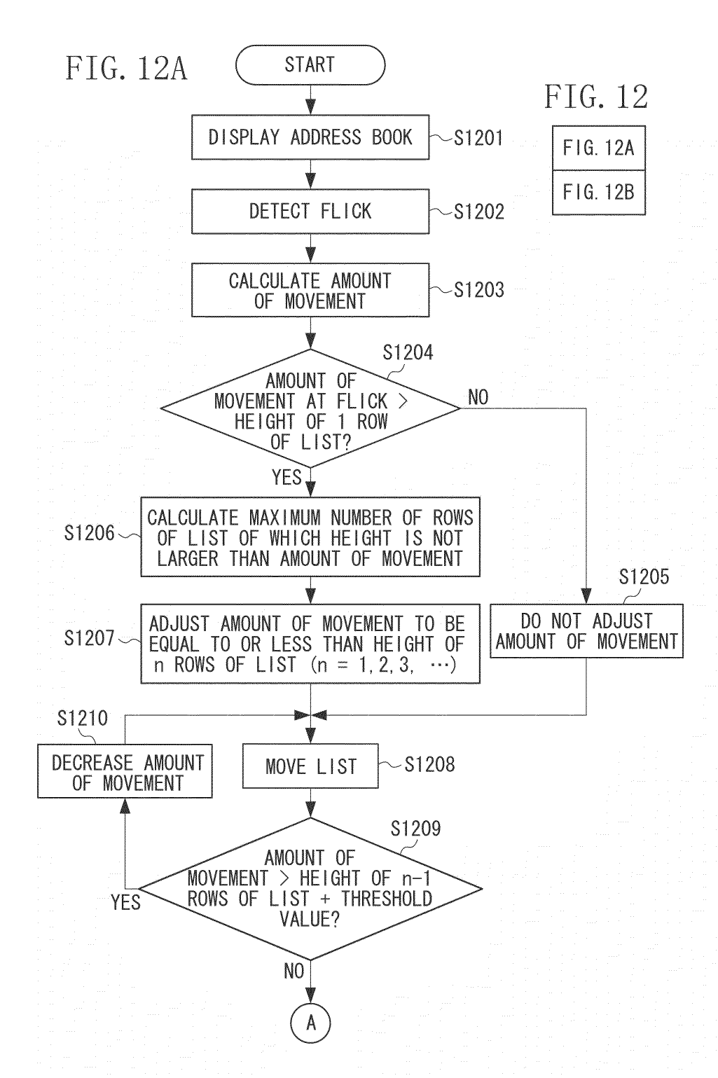

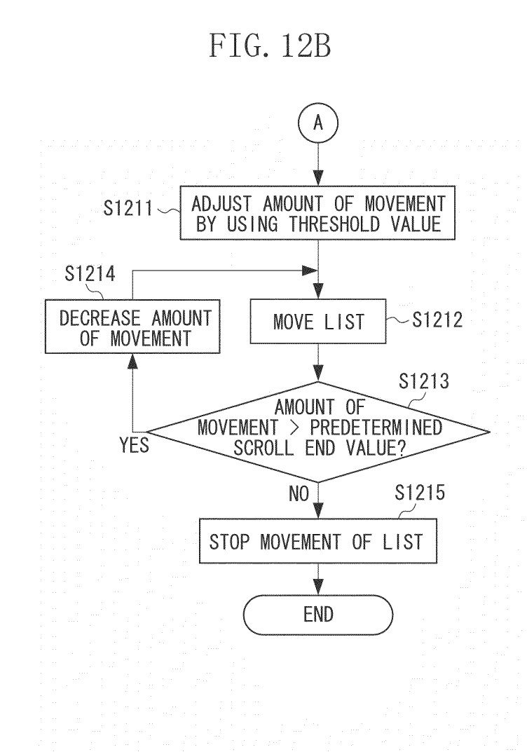

FIG. 12, comprising FIGS. 12A and 12B, is a flowchart illustrating example processing performed by the information processing apparatus according to the present embodiment.

Specifically, the following describes example processing performed when the user uses the E-mail send function, one of data transmission functions provided by the information processing apparatus 101, i.e., an example case of selecting an E-mail address as described above with reference to FIG. 2. Processing in FIG. 12 is implemented when the CPU 111 reads programs stored in the ROM 113 or the external memory 120 and then executes these programs.

Processing in steps S1201 to S1208 and processing in step S1210 illustrated in FIG. 12 are equivalent to the processing in step S1001 to S1008 and the processing in step S1010 illustrated in FIG. 10, respectively. Further, processing in steps S1212 to S1215 illustrated in FIG. 12 is equivalent to the processing in steps S607 to S610 illustrated in FIG. 6, respectively. Therefore, descriptions of the relevant processing will be omitted, and descriptions will be made centring on processing in steps S1209 and S1211 illustrated in FIG. 12.

In step S1209, the CPU 111 determines whether the amount of movement in pixels exceeds a value of the sum of the height of n−1 rows of the list and a predetermined threshold value. The predetermined threshold value in this case is any value from 0 to 30 pixels, which equals the list height 202, and is preset. For example, when the relevant threshold value is 0 pixels, the CPU 111 performs the same processing as the processing described above in the third embodiment. The present exemplary embodiment will be described below assuming that the threshold value is 15 pixels.

In step S1211, when the amount of movement in pixels becomes equal to or less than a value of the product of the integral quotient (n=2) minus 1 and the distance between contents (30 pixels) (NO in step S1209), then in step S1211, the CPU 111 readjusts the amount of movement in pixels by using a threshold value. Specifically, the CPU 111 sets the amount of movement in pixels to 15 pixels.

When the amount of movement in pixels exceeds a value of the sum of the height of n−1 rows of the list and a preset threshold value (YES in step S1209), the processing proceeds to step S1210.

When the amount of movement in pixels after readjustment becomes equal to or less than a predetermined value (for example, equal to or less than a preset scroll end value), the CPU 111 performs control to stop the movement of the list, i.e., the screen scroll operation.

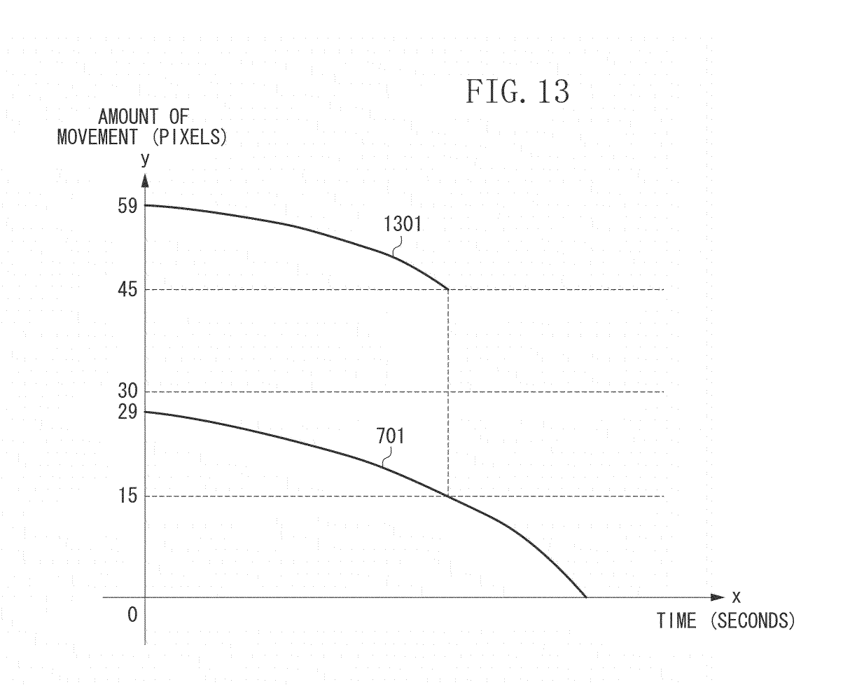

FIG. 13 illustrates screen scroll operations by a flick operation by the user in the case of the control processing illustrated in FIG. 12.

Referring to the graph illustrated in FIG. 13 the vertical axis (y axis) is assigned the amount of movement in pixels from the last update to the next update, and the horizontal axis (x axis) is assigned time (seconds). Further, parabolas 701 and 1301 illustrate operations of the inertial scrolling in which the amount of movement (amount of scroll) decreases with time. The parabola 701 is identical to that described above with reference to FIG. 7.

Referring to the parabola 1301, it can be seen that the amount of movement in pixels is adjusted to 59 pixels by the processing in step S1207 since the amount of movement in pixels is calculated to be 80 pixels by the processing in step S1203 illustrated in FIG. 12.

Further, the CPU 111 gradually decreases the amount of movement in pixels from 59 pixels at the start of scrolling, and, when the amount of movement becomes 45 pixels which equals a value of the sum of the height of n−1 rows of the list and a preset threshold value, adjusts the amount of movement in pixels to 15 pixels. Subsequently, the CPU 111 gradually decreases the amount of movement from 15 pixels.

In the information processing apparatus according to the present embodiment, the amount of movement in pixels from the last update to the present update in the inertial scrolling is adjusted to be equal to or less than the height of n rows of the list. Further, when the amount of movement in pixels becomes a value of the sum of the height of n−1 rows of the list and a preset threshold value, the amount of movement in pixels is adjusted by using a threshold value. Therefore, the amount of movement in pixels at the start of scrolling can be changed according to the strength of a flick performed by the user while preventing the occurrence of an optical illusion.

Further, since screen scrolling is controlled to be gradually slowed down from a preset threshold value, the user can grasp (visually recognize) the contents of the address list even during scrolling.

The above-described embodiments describe the present invention specifically, and the scope of the present invention is not limited thereto. The present invention also includes embodiments modified in diverse ways without departing from the spirit and scope thereof. For example, parts of the above-described embodiments may be combined as appropriate.

For example, the contents scrollably displayed in the display screen on the display 119 are not limited to an address selection screen. The present invention is applicable to the display of all other types of data as long as scroll operations are used for screen display.

In the above-described example case according to each embodiment, a screen scroll operation in the upward direction has been described. The direction of scrolling is not limited thereto. The present invention is applicable to scrolling in all directions including scrolling in the upward and the downward directions and scrolling in the right and the left directions.

The information processing apparatuses according to the above-described embodiments are applicable to diverse types of apparatuses, such as personal computers, personal data assistants (PDAs), and cellular phone terminals. The present invention is also applicable to printers, scanners, facsimiles, and copying machines, as well as to multifunction peripherals, cameras, video cameras, and other image viewers having these functions.

Control of various processing including control of the amount of movement in pixels according to the present embodiment can also be implemented by installing processing control programs (computer programs) in a computer. Further, it is natural that a recording medium storing processing control programs executable by a computer is also included in the scope of the present invention.

According to the present exemplary embodiment, it is possible to prevent the occurrence of the wagon wheel effect during scrolling of displayed contents. This enables the user to easily recognize in which direction the screen is scrolling.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed embodiments. The scope of the following claims is to be accorded the broadest interpretation so as to encompass all such modifications and equivalent structures and functions.

This application claims the benefit of Japanese Patent Application No. 2014-055014 filed Mar. 18, 2014, and Japanese Patent Application No. 2015-033993 filed Feb. 24, 2015, which are hereby incorporated by reference herein in their entireties.

What is claimed is:

1. An information processing apparatus comprising:
a display unit configured to display a list of a plurality of contents in a predetermined display area;
a reception unit configured to receive an operation for performing inertial scrolling on the displayed contents in the display area; and
a display control unit configured to perform inertial scrolling on the contents in the display area based on the received operation while updating the contents at predetermined time intervals, based on the received operation,
wherein the display control unit is configured to control an amount of scroll movement of the contents for each of the predetermined time intervals to be equal to or less than a height of one row of the list.

2. The information processing apparatus according to claim 1, wherein the display control unit is configured to control the amount of scroll movement of the contents for each of the predetermined time intervals at a start of the inertial scrolling to be equal to or less than the height of one row of the list.

3. The information processing apparatus according to claim 1, further comprising:
a calculation unit configured to calculate the amount of scroll movement of the contents for each of the predetermined time intervals at a start of the inertial scrolling, according to a characteristic of the received operation,
wherein, when the amount of scroll movement of the contents for each of the predetermined time intervals calculated by the calculation unit exceeds the height of one row of the list, the display control unit is configured to control the relevant amount of scroll movement to be equal to or less than the height of one row of the list.

4. The information processing apparatus according to claim 3, wherein the reception unit is configured to receive a flick operation as the operation for performing inertial scrolling, and
wherein, according to a flick strength or a flick speed in the flick operation, the calculation unit is configured to calculate the amount of scroll movement of the contents for each of the predetermined time intervals at the start of the inertial scrolling.

5. The information processing apparatus according to claim 4, further comprising:
an adjustment unit configured to, when the amount of scroll movement of the contents for each of the predetermined time intervals calculated by the calculation unit exceeds the height of one row of the list, adjust a speed reduction rate of the inertial scrolling according to the relevant flick strength or flick speed.

6. The information processing apparatus according to claim 1, wherein, when the amount of scroll movement of the contents for each of the predetermined time intervals becomes equal to or less than a predetermined value, the display control unit stops the scrolling of the contents.

7. The information processing apparatus according to claim 1, wherein a plurality of contents displayed in the display area is an address book.

8. The information processing apparatus according to claim 1, further comprising:
a reading unit configured to read an image on a document and generate image data for display in the display area.

9. The information processing apparatus according to claim 1, further comprising:
a printing unit configured to print image data displayed in the display area.

10. A method for controlling an information processing apparatus comprising a display unit configured to display a list of a plurality of contents in a predetermined display area, and a reception unit configured to receive an operation for performing inertial scrolling on the displayed contents in the display area, the method comprising:
performing display control to perform inertial scrolling on the contents in the display area based on the received operation while updating the contents at predetermined time intervals; and,
wherein, in the display control, an amount of scroll movement of the contents for each of the predetermined time intervals is controlled to be equal to or less than a height of one row of the list.

11. A non-transitory computer-readable storage medium having stored thereon programs for causing a computer to execute the control method according to claim 10.

12. An information-processing apparatus substantially as herein described and as illustrated in FIGS. 1, 2 and 4.

13. A control method substantially as herein described and as illustrated in FIGS. 6, 8, 10, 12A and 12B.
